(19) United States
(12) Patent Application Publication
(10) Pub. No.: US 2006/0245728 A1
(43) Pub. Date: Nov. 2, 2006

(54) Memory device recording medium recording therein data processing the program data processing system and data processing method

(76) Inventors: Hiroshi Mukaihara, Tokyo (JP); Kunihiko Shimoda, Tokyo (JP)

Correspondence Address: William S. Frommer;Frommer Lawrence & Haug, 745 Fifth Avenue, New York, NY, 10151, US

(21) Appl. No.: 10/566,871

(22) PCT Filed: Jul. 27, 2004
(86) PCT No.: PCT/JP04/11024

§ 371 Date: Feb. 2, 2006

(30) Foreign Application Priority Data
Aug. 6, 2003 (JP) 2003-287723

(51) Int. Cl. H04N 7/00

(52) U.S. Cl. 386/96

(57) ABSTRACT

A memory device storing a program easily allowing to view image data and audio data with simple operations, a recording medium, the program, a data processing system and a data processing method. After a reproduction program (16) and an automatic activation program are stored once in PC 1 and when a memory device (10) is connected to a USB interface (6) of PC 1, the reproduction program (16) is automatically activated and image data and the like stored in the memory device (10) can be reproduced. Namely, for example, image data and the like can be viewed easily as if a switch of a television is turned on, and it is very convenient.

### TECHNICAL FIELD

The present invention relates to a memory device storing a program for processing, for example, data of still images and moving images and audio data, a recording medium, the program, a data processing system and a data processing method.

### BACKGROUND ART

In order to view images picked up by a digital camera or the like on a monitor of a PC (Personal Computer) or the like, a conventional technique allows a user to easily transfer image data from a digital camera to PC and view the image. This technique adopts the configuration that program data for reproduction, editing and the like of an image file by using PC is stored beforehand on a digital camera side so that this program is not required to be installed in PC (e.g., refer to Japanese Patent Application Publication No. HEI 09-312791 (Paragraph [0023], FIG. 1)).

There is another technique in which image data in a memory card picked up by a digital camera is automatically transferred to a storage server at a physically remote location when the memory card is connected to PC or the like (e.g., refer to Japanese Patent Application Publication No. 2002-32302 (Paragraphs [0062] to [0067], FIG. 5, etc.)).

In a system described in Japanese Patent Application Publication No. HEI 09-312791, in order to view an image picked up by the digital camera, a user is inconveniently required to activate the image reproduction program automatically installed in PC or the like. It is expected that a user can have very high convenience if images and music can be enjoyed easily on PC similar to, for example, enjoying movie or the like on a television.

Under the above-described circumstances, an object of the present invention is to provide a memory device storing a program allowing to easily view and listen image data and audio data with simple operations, a recording medium, the program, a data processing system and a data processing method.

### DISCLOSURE OF THE INVENTION

In order to achieve the above object, a memory device of the present invention, which is a portable memory device, includes (a) a terminal capable of being connected to an interface mounted on a host machine and capable of data input/output from/to the host machine and (b) a storage element for storing at least one of image data and audio data, reproduction program data for the host machine to reproduce at least one of the image data and audio data, and execution program data for the host machine to execute a program of the reproduction program data in response to a detection signal that the host machine detects a connection of the terminal to the interface.

In the present invention, the host machine is a machine having a computer function. The image data includes a still image file and a moving image file. These are applied also to the following description.

According to the present invention, after the reproduction program and execution program are installed once in the host machine, the reproduction program can be automatically activated and image data and the like stored in the memory device can be reproduced when the interface of the host machine is connected to the terminal of the memory device. Viewing image data and the like can be made more convenient.

If the host machine does not store the reproduction program data and execution program data, the memory device may store a program for automatically or manually installing the reproduction program data and execution program data in the host machine. In this case, in response to that the terminal of the memory device is connected to the host machine, the install program can be executed to install the reproduction program and execution program. At a result, even an apparatus other than the host machine can reproduce image data and the like stored in the memory device by using the reproduction program and execution program.

According to an embodiment of the present invention, if the host machine stores beforehand at least the reproduction program data and execution program data and when the terminal is connected to the interface in the state that the storage element stores at least one of the image data and audio data, the host machine activates the execution program in response to the detection signal to read and reproduce at least one of the image data and audio data stored in the memory element.

A recording medium of the present invention records a program for making a host machine having an interface capable of data input/output execute the program which includes (a) a step of detecting a detection signal indicating that a terminal of a portable memory device is connected to the interface and (b) a step of executing a program in a reproduction program data for reproducing at least one of image data and audio data stored in the memory device, in response to the detection signal.

According to an embodiment of the present invention, if the host machine stores at least one of the image data and audio data and the reproduction program data and the execution program data before the step (a), the host machine is made to execute before the step (a) a step (c) of outputting at least one of the image data and audio data to the memory device and a step (d) of controlling to output the reproduction program data and execution program data to the memory device at the same time as, during or after the step (c), in the state that the terminal of the memory device is connected to the interface. Accordingly, as a user outputs the image data and the like to the host machine, the reproduction program data and execution program data can also be output to the host machine without user recognition. Therefore, for example, if the memory device stores a program for automatically or manually installing these program data in the host machine, the following process can be executed. Namely, when a user desires to view the image and the like stored in the memory device on an apparatus other than the host machine, the install program can be executed to install the reproduction program and execution program in the other apparatus, in response to that the other apparatus detects a connection of the terminal of the memory device to an interface. It is therefore convenient in that the other apparatus can read and reproduce the image data and the like stored in the memory device.

A data processing system of the present invention includes (a) a host machine having an interface capable of data input/output, and (b) a portable memory device having a terminal capable of being connected to said interface, and a storage element for storing at least one of image data and audio data, reproduction program data for the host apparatus to reproduce at least one of the image data and audio data, and execution program data for the host machine to execute a program in the reproduction program data in response to a detection signal that the host machine detects a connection of the terminal to the interface.

According to the present invention, for example, if the host machine stores in advance the reproduction program data and execution program data and when the terminal of the memory device is connected to the interface of the host machine, the reproduction program can be activated automatically to reproduce the image data and the like. It becomes therefore more convenient in viewing the image data and the like.

According to an embodiment of the present invention, an external apparatus is further provided being connected to the host machine via a network, and the host machine has a means for controlling to activate the execution program in response to the connection detection signal and outputting at least one of the image data and audio data to the external apparatus via the network, when the terminal is connected to the interface in the state that at least one of the image data and audio data is stored in the storage element. Accordingly, for example, if the external apparatus stores the reproduction program data and execution program data, the image and the like can be viewed merely by connecting the memory device to the host machine.

A data processing method of the present invention includes (a) a step of detecting a detection signal by a host machine having an interface capable of data input/output, the detection signal indicating that the interface is connected to a terminal of a portable memory device and (b) a step of executing a program in reproduction program data for reproducing by the host machine at least one of image data and audio data stored in the memory device in response to the detection signal.

As described above, according to the present invention, image data and audio data can be viewed easily with simple operations.

### BRIEF DESCRIPTION OF THE DRAWINGS

FIG. 1 is a diagram showing the configuration of a data processing system according to an embodiment of the present invention.

FIG. 2 is a flow chart illustrating the operation of the system shown in FIG. 1.

FIG. 3 is a diagram showing an example of a screen displayed on a display when a data write work is performed for a memory device.

FIG. 4 is a diagram showing an example of a screen displayed on the display when a data write work is performed for the memory device.

FIG. 5 is a diagram showing an example of a screen displayed on the display when a data write work is performed for the memory device.

FIG. 6 is a flow chart illustrating an operation of reproducing image data or the like.

FIG. 7 is a diagram showing an example of a screen displayed on the display by a reproduction program with a GUI function.

FIG. 8 is a diagram showing an example of a screen displayed on the display by a reproduction program with a GUI function.

FIG. 9 is a diagram showing the configuration of a data processing system according to another embodiment of the present invention.

### BEST MODE FOR CARRYING OUT THE INVENTION

In the following, embodiments of the present invention will be described with reference to the drawings.

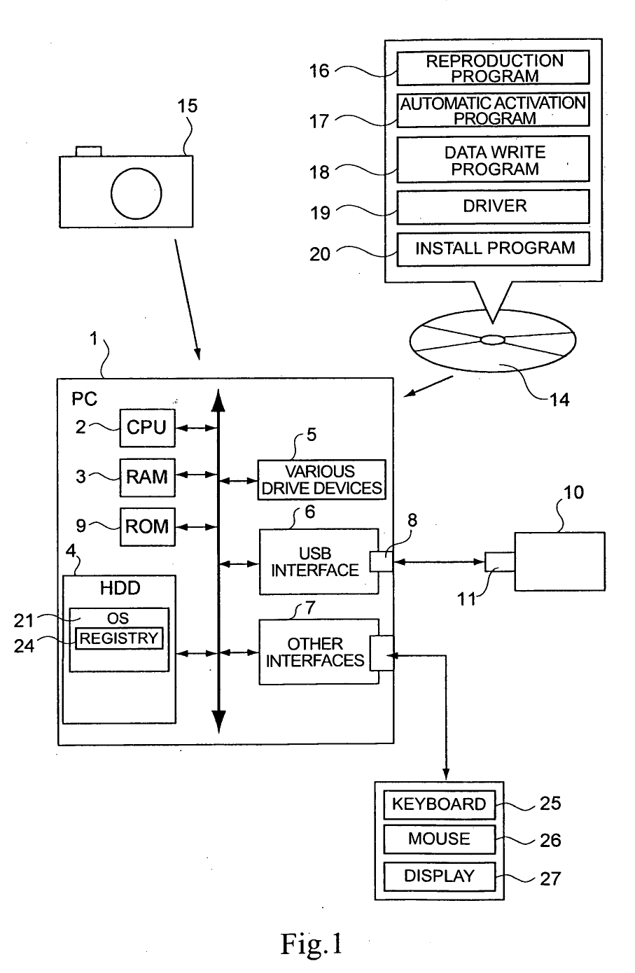

FIG. 1 is a diagram showing the configuration of a data processing system according to an embodiment of the present invention. The data processing system has as a host machine, for example, a PC 1. PC 1 has a CPU (Central Processing Unit) 2 for executing general control such as arithmetic processing, a RAM (Random Access Memory) 3 as a working space for processing by CPU 2, an HDD (Hard Disk Drive) 4 for storing predetermined software such as an OS (Operating System) 21, a ROM 9 and the like. PC 1 has also a USB (Universal Serial Bus) interface 6 for example, other interfaces 7 for parallel communications and the like, and various drive devices 5 such as a CD-ROM drive, a floppy (registered trademark) disk drive. Operation devices such as a keyboard 25, a mouse 26 and a display 27 are connected to the interface 7.

Reference numeral 15 represents a digital camera. PC 1 can store image data including, e.g., moving image data and the like picked up by the digital camera 15 in HDD 4. The digital camera 15 is used by way of example to store image data in PC 1. Data to be stored is not limited to image data, but it is obvious that only audio data such as a music file may also be stored.

A memory device 10 has therein storage elements such as a semiconductor memory not shown, and is provided with a connection terminal 11 corresponding to USB. In the state that the connection terminal 11 is connected to a USB port 8 provided on the USB Interface 6, PC 1 accesses the memory device 10 and can read data stored in the memory device 10 or write data possessed by PC 1 in the memory device 10. The memory device 10 may be a portable flash memory.

Recorded in a recording medium 14 such as a CD-ROM are a reproduction program 16, an automatic activation program 17, a data write program 18, a driver 19, an install program 20 and the like. For example, a user copies and installs the programs 16 to 20 recorded in the recording medium in PC 1 to allow the user to use the programs 16 to 19 on PC 1.

The reproduction program 16 is a program for reproducing image data and the like picked up by the digital camera 15 or the like. The reproduction program reproduces image data and audio data by using, e.g., GUI (Graphical User Interface). The automatic activation program 17 executes the reproduction program 16 in response to a detection signal of PC 1 detecting that the terminal 11 of the memory device 10 is connected to the USB port 8. The data write program 18 is a program for writing image data picked up by the digital camera 15 in the memory device 10. The driver 19 is a program for operating the memory device 10 on PC 1. The install program 20 is a program for installing the programs 16 to 19 in PC 1.

Examples of OS 21 of PC 1 are Windows (registered trademark) 95, 98, 2000, XP of Microsoft Corporation and the like. These OSes support a plug-and-play function at, for example, the USB interface 6. Plug-and-play operates as follows. For example, as certain hardware is connected to a system, the system acquires identification information unique to the hardware from the hardware, and a driver of the hardware corresponding to the identification information is automatically activated. In this embodiment, for example, if a driver (e.g., driver 19) corresponding to hardware (e.g., memory device 10) is registered in the registry 24, PC 1 automatically activates the driver. On the other hand, if the driver corresponding to the hardware is not registered in the registry 24, PC 1 recommends to search and install an optimum driver or automatically activates the install program.

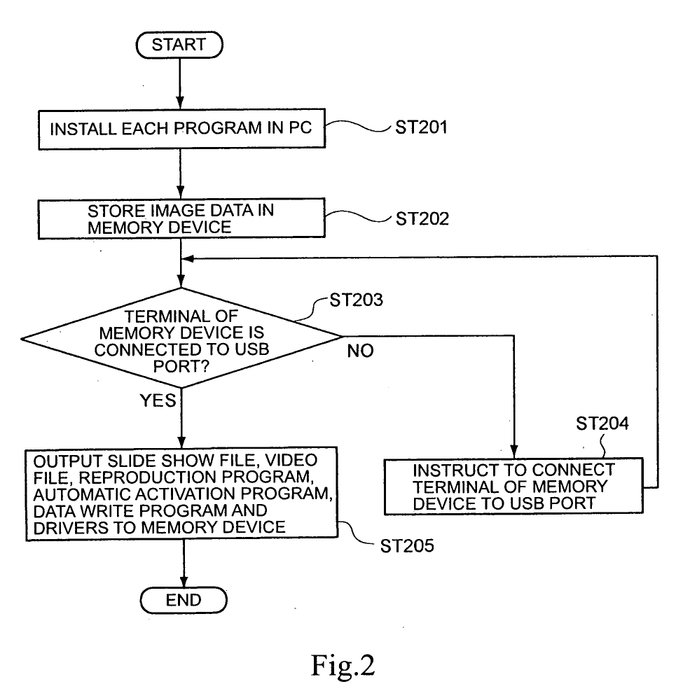

Next, description will be made on the operation of the system constructed as above. FIG. 2 is a flow chart illustrating the operation.

It is first assumed that PC 1 has image data and video data picked up by the digital camera 15 stored by a user beforehand in HDD 4. A user copies the programs 16 to 20 recorded in the recording medium 14 in HDD 4 of PC 1, and the programs 16 to 19 are installed to register setting information on each program (Step 201).

If the driver 19 recorded in the recording medium 14 is not installed in PC 1 and a user connects the memory device 10 to the USB interface 6, CPU 2 instructs to install the driver 19 through plug-and-play as described above.

After the programs 16 to 19 are installed, for example, a user works to store a portion or the whole of the image data stored in PC 1 in the memory device (Step 202). This work is performed by using the data write program 18 installed at Step 201. In this embodiment, this write work in the memory device 10 will be described together with, for example, in the case of a still image file, a work of creating a slide show using still images.

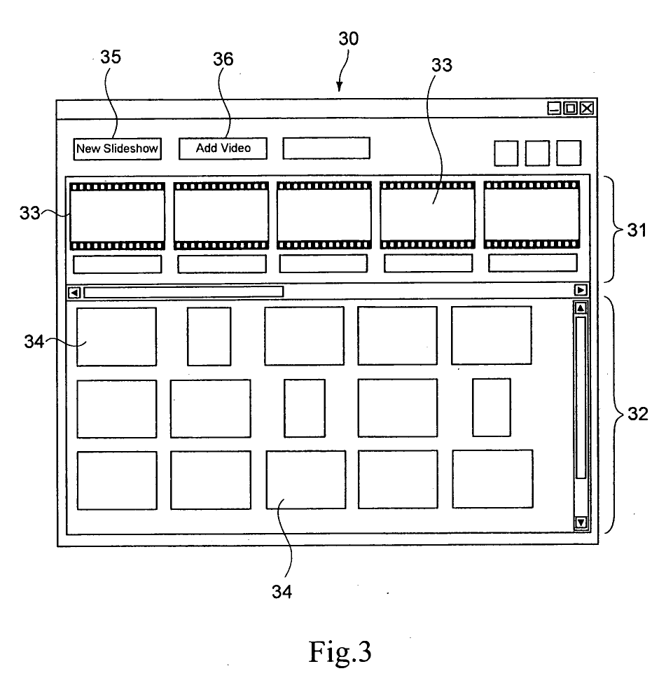

FIGS. 3, 4 and 5 show screens displayed on the display 27 when the write work is performed. As the data write program 18 is activated, CPU 2 opens a fundamental screen 30 such as shown in FIG. 3. For example, if there exist already created slide show and video files 33., these files are displayed in boxes 31. Displayed in the box 32 is an image file 34 in the folder presently selected by a user. If the user wishes to create, for example, a file or slide show, a new slide show button 35 is depressed to start a slide shown file creation procedure. For example, files 33, 34 and the like are displayed as icons or as reduced images so that the user can easily locate them.

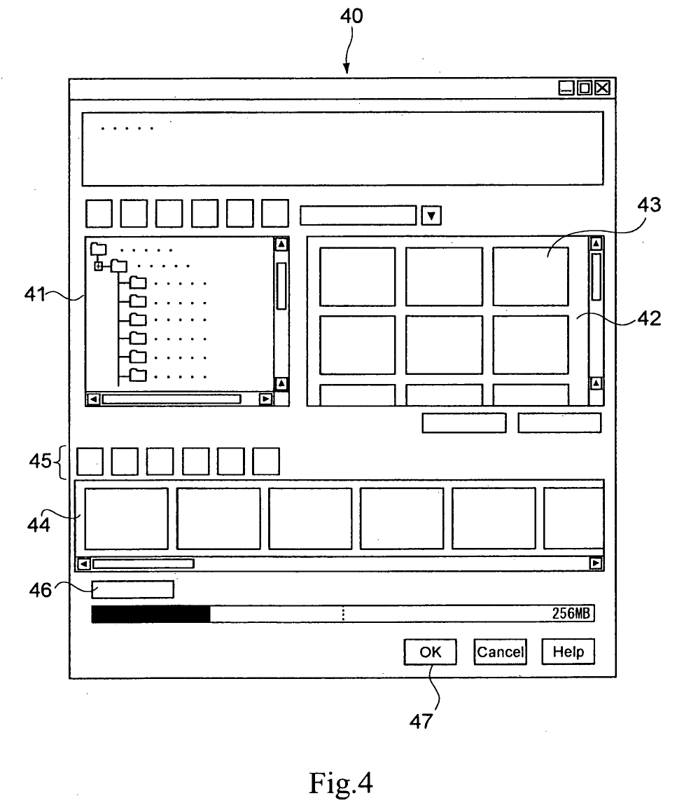

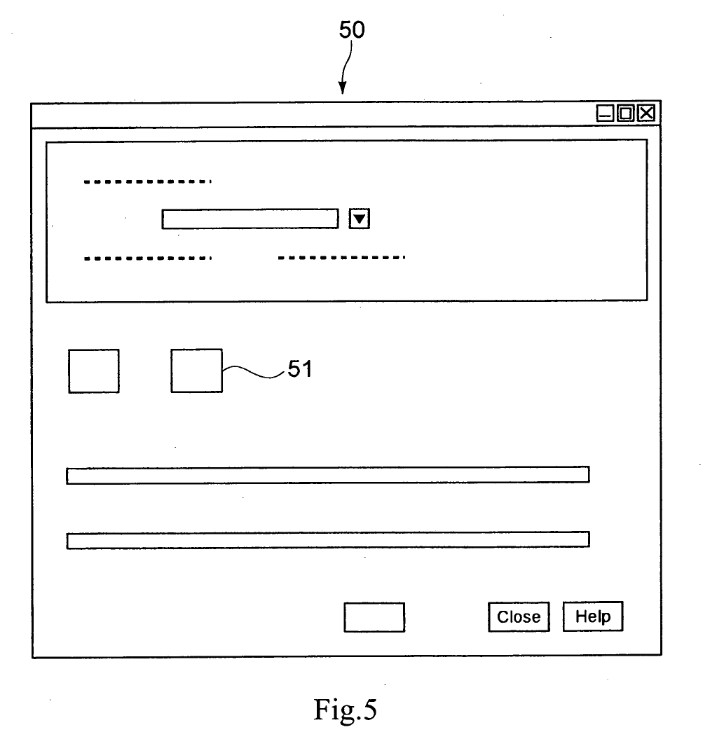

As the user depresses the new slide show button 35, a dialog box 40 such as shown in FIG. 4 is opened. As the user selects a folder storing image files constituting a slide show to be created, files 43 in the folder are displayed in a file window 42. The user selects a file 43 in the file window 42 and moves it to an image list box 44 through drag-and-drop, to thereby decide the image file to be used for the slide show. Slide show tool buttons 45 are used for deletion, rotation, slide order and the like of the selected slide. BGM of the slide show can be selected from music stored in the recording medium by using a back music button 46. Adding a video file and the like can be performed by a method similar to that of creating the slide show, as the user clicks an add video button 36. As the user depresses an OK button 47, files constituting the slide show or video files are decided and the decided files are stored in a temporarily folder or the like of OS 21. Then, CPU 2 displays a screen 50 such as shown in FIG. 5. In this screen 50, as the user depresses, for example, a start button 51, slide show files are created. The created files and selected video files are output to the memory device 10.

As the start button 51 is depressed, CPU 2 confirms whether the memory device 10 is connected to the USB interface 6, i.e., whether the terminal 11 of the memory device 10 is connected to the USB port 8 (Step 203) (refer to FIG. 2). If the memory device 10 is not connected, the user is instructed to connect the memory device (Step 204). If the memory device 10 is being connected, CPU 2 outputs the slide show files and video files stored in the temporary folder or the like as well as the reproduction program 16, automatic activation program 17, data write program 18, driver 19 and install program 20 stored in HDD 4, to the memory device 10 (Step 205).

The write work of an image file into the memory device 10 has been described above together with the slide show file creating work. The embodiment is not limited thereto, but after the slide show files are created, the user may store once the files in HDD 4 of PC 1 as a user designated folder. It is obvious that only the video files are output to the memory device 10.

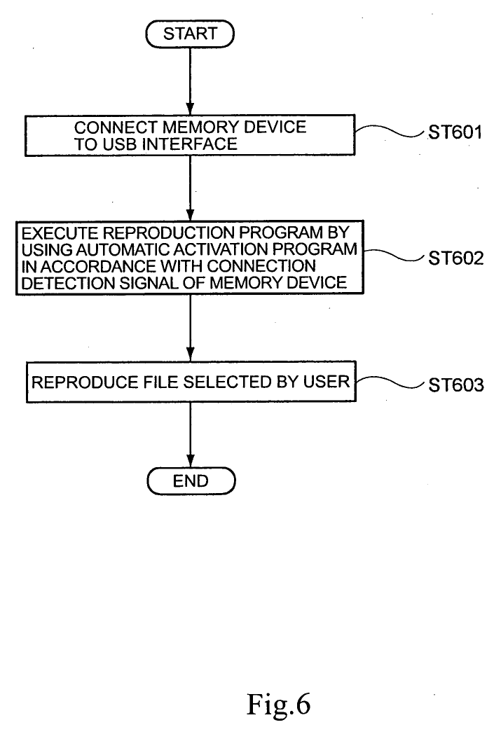

Next, description will be made on the operation of reproducing the slide show files and video files stored in the memory device 10, by using the memory device, to be executed by the user. FIG. 6 is a flow chart illustrating the operation.

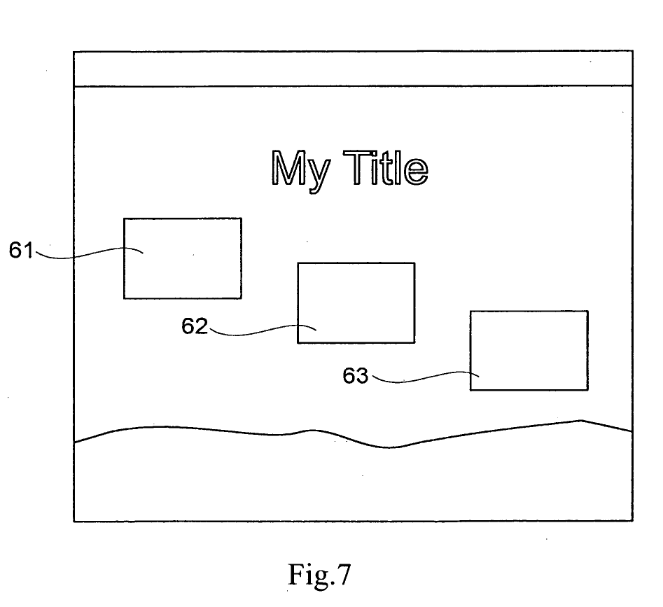

For example, as the user connects the memory device 10 to the USB interface 6 (Step 601), CPU 2 detects its connection, and in response to this detection signal, executes the reproduction program 16 having the GUI function stored in HDD by using the automatic activation program 17 (Step 602). FIG. 7 shows a screen displayed on the display 27 by the GUI function. As shown in FIG. 7, in an initial screen, for example, two slide show files 61 and 62 and a video file 63 are displayed as icons. As one file is selected by the user, CPU 2 accesses the memory device 10 via the USB interface 6 and reproduces the file (Step 603).

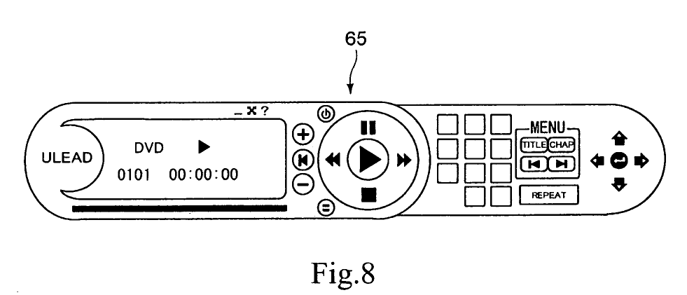

If a file to be reproduced is a music file containing only sounds, the reproduction program 16 having the GUI function such as shown in FIG. 8 is executed by the operation similar to that of Steps 601 to 603, and the music file is reproduced by using the reproduction program. Reference numeral 65 represents a GUI display screen of the reproduction program.

As described above, according to the embodiment, after the reproduction program 16 and automatic activation program are installed once in PC 1, the reproduction program 16 is automatically activated when the memory device 10 is connected to the USB interface 6 of PC 1, and image data and the like stored in the memory device 10 can be reproduced. Namely, for example, image data and the like can be viewed easily as if a switch of a television is turned on, and it is very convenient.

Further, according to the embodiment, for example, if a user wishes to reproduce and view image data and the like stored in the memory device 10 on a second PC (not shown) different from PC 1, the second PC can execute the following processing. For example, as a user connects the memory device 10 to a USB interface possessed by the second PC, the second PC searches a driver for operating the memory device 10 through plug-and-play. Since the second PC does not have the driver, it is recommended to install an optimum driver. The user operates the second PC to install the driver 19 stored in the memory device 10 and install the reproduction program 16 and automatic activation program 17 in the second PC. This installation can be performed by using the install program 20 stored in the memory device 10. Alternatively, if the second PC does not have the driver, it may access the memory device and automatically install an optimum driver (driver 19) by using the install program 20. Thereafter, by merely connecting again the memory device 10 to the USB Interface, the reproduction program can be automatically activated by the automatic activation program 17 and image data and the like can be reproduced.

Next, description will be made on another embodiment of the present invention.

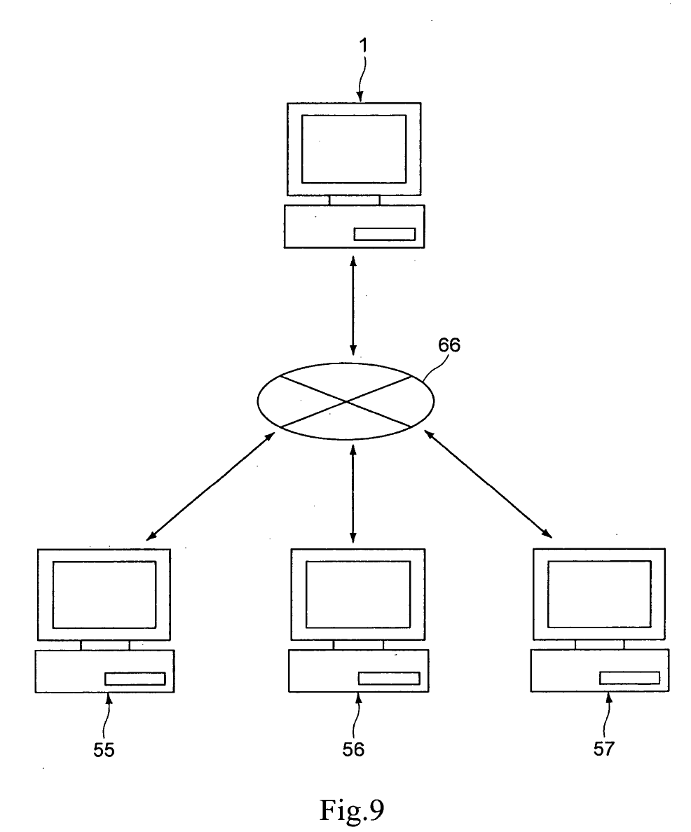

FIG. 9 shows an embodiment. For example, PC 1 is connected to a plurality of other PCs 55, 56 and 57 via a network 66 such as LAN (Local Area Network) so that data communications are possible. Identification information unique to PCs 55, 56 and 57 is stored in HDD 4 of PC 1. For example, if the network 66 uses TCP/IP (Transmission Control Protocol/Internet Protocol), IP addresses are used as the identification information. For example, PC 1 sets beforehand some or all of the identification information of PCs 55, 56 and 57, and installs software for automatically transferring data to PCs whose identification information was set.

In the system of this type, for example, it is assumed that a user connects the memory device 10 to the USB interface 6 of PC 1. As described in the first embodiment, PC 1 detects the connection and in response to the detection signal, activates the reproduction program 16 by using the automatic activation program 17. PC 1 reproduces image data and the like, and by using the above-described software, reads the registered identification information of a predetermined PC to automatically transfer image data to be reproduced to the PC. The PC received the image data automatically activates the same reproduction program 16 installed in advance and reproduce the received image data approximately at the same time as that at PC 1. In this case, it is necessary to install the programs 16 to 19 from the storage medium 14 to PCs 55, 56 and 57. Alternatively, the memory device 10 in the state at Step 205 shown in FIG. 2 may be connected to PCs 55, 56 and 57 to install the programs 16 to 19.

Alternatively, when the memory device 10 is connected to the USB interface 6 of PC 1 and the reproduction program 16 is automatically activated, PC 1 may output a signal for automatically activating the reproduction program in accordance with the identification information, to PC corresponding to the identification information. Approximately at the same time as the timing when PC 1 reproduces image data, the corresponding PC may reproduce the same image data. Namely, in the former example, signals when PC 1 reproduces image data are output to a predetermined PC. In the latter example, a signal when PC 1 automatically activates the reproduction program is output to a corresponding predetermined PC.

PC 1 may set beforehand which data among image data stored in the memory device 10 is to be transferred.

As described above, according to the embodiment, the reproduction program automatically activated at PC 1 can be automatically activated approximately at the same time at PCs 55, 56 and 57 connected to the network 66, and the image data reproduced at PC 1 can be automatically reproduced approximately at the same time at PCs 55, 56 and 57. If the embodiment is applied to an office or the like having a LAN environment for example, it is effective in that a plurality of people can view image data approximately at the same time.

Description will be made on a case wherein, the network 66 of the system shown in FIG. 9 is, for example, the Internet and PC 55 is a server 55′ on the Web possessed by an individual. In this case, a user of PC 1 can automatically upload image data and the like to a web site provided by the server 55′. More specifically, as a user connects the memory device 10 to the USB interface 6 of PC 1, and the reproduction program is automatically activated in response to a connection detection signal. PC 1 can automatically upload image data and the like stored in the memory device to the predetermined server 55′.

If the network 66 of the system shown in FIG. 9 is, for example, the Internet or the like and PC 56 is a server 56′ of so-called on-line storage service for providing services of storing image data and the like on the Web, PC 1 may automatically transfer and store image data and the like to the server 56′.

According to the embodiment, for example, if PC 1 is a lap top type PC, photograph images, moving images and the like photographed outdoors by a user are stored in the memory device 10. By connecting the memory device 10 to PC 1, image data can be automatically transferred to the server 55′ or 56′. This configuration is very convenient as compared to conventional manual upload. Image files such as photograph images and moving images among others are often photographed at a location different from a user house. Therefore, automatic transfer of this type can dispense with cumbersome works of uploading from a location different from a user house.

If the network 66 of the system shown in FIG. 9 is the Internet or LAN, PC 57 may be a backup server 57′. Also in this case, when the memory device 10 is connected to the USB interface 6 and the reproduction program 16 is automatically activated in response to a connection detection signal, PC 1 can automatically store image data and the like stored in the memory device 10, in the predetermined backup server 57′.

1-8. (canceled)

9. A memory device of a portable type comprising:
(a) a terminal capable of being connected to an interface mounted on a host machine and capable of data input/output from/to said host machine, and
(b) a storage element for storing
at least one of image data and audio data,
reproduction program data for said host machine to reproduce at least one of said image data and audio data, and
execution program data for said host machine to execute a program in said reproduction program data and a write program to write at least one of said image data and audio data from said host machine to said storage element in response to a detection signal that said host machine detects a connection of said terminal to said interface.

10. The portable memory device as described in claim 9, wherein if said host machine stores beforehand at least said reproduction program data and execution program data, and when said terminal is connected to said interface in the state that said storage element stores at least one of said image data and audio data, said host machine activates said execution program in response to said detection signal to read and reproduce at least one of said image data and audio data stored in said memory element.

11. A recording medium recorded therewith programs, said programs comprising:
a program for making a host machine having an interface capable of data input/output execute said program, said program having
(a) a step of detecting a detection signal indicating that a terminal of a portable memory device is connected to said interface, and
(b) a step of executing a program in a reproduction program data for reproducing at least one of image data and audio data stored in said memory device, in response to said detection signal; and
a write program to write at least one of said image data and audio data from said host machine to said storage element.

12. The recording medium as described in claim 11, wherein if said host machine stores at least one of said image data and audio data and said reproduction program data and said execution program data before said step (a), said host machine is made to execute before said step (a),
(c) a step of outputting at least one of said image data and audio data to said memory device, and
(d) a step of controlling to output said reproduction program data and said execution program data to said memory device at the same time as, during or after the step (c),
in the state that said terminal of said memory device is connected to said interface.

13. A data processing system comprising:
(a) a host machine having an interface capable of data input/output, and
(b) a portable memory device having a terminal capable of being connected to said interface, and a storage element for storing at least one of image data and audio data, reproduction program data for said host apparatus to reproduce at least one of said image data and audio data, execution program data for said host machine to execute a program in said reproduction program data in response to a detection signal that said host machine detects a connection of said terminal to said interface, and a write program to write at least one of said image data and audio data from said host machine to said storage element.

14. The data processing system as described in claim 13, said system further having an external apparatus connected to said host machine via a network, wherein said host machine comprises a means for controlling to activate said execution program in response to said connection detection signal and outputting via said network at least one of said image data and audio data to said external apparatus designated by a user beforehand, when said terminal is connected to said interface in the state that at least one of said image data and audio data is stored in said storage element.

15. The portable memory device as described in claim 9, wherein said write program, executed in said host machine, displays on a same display an icon or a reduced image of a file of image data stored in said memory device, and writes a selected file to said memory device.
